(19) United States
(12) Patent Application Publication
(10) Pub. No.: US 2024/0085384 A1
(43) Pub. Date: Mar. 14, 2024

(54) CHROMATOGRAPH

(71) Applicant: Shimadzu Corporation, Kyoto (JP)

(72) Inventor: Yusuke INOHANA, Kyoto-shi (JP)

(73) Assignee: Shimadzu Corporation, Kyoto (JP)

(21) Appl. No.: 18/272,707

(22) PCT Filed: Sep. 9, 2021
(86) PCT No.: PCT/JP2021/033144

§ 371 Date: Jul. 17, 2023

(30) Foreign Application Priority Data
Jan. 26, 2021 (JP) 2021-010122

(51) Int. Cl. G01N 30/72; B01D 15/08; G01N 30/86

(52) U.S. Cl. CPC G01N 30/7233; B01D 15/08; G01N 30/86; G01N 2030/027

(57) ABSTRACT

A chromatograph including: a column 13 configured to separate a compound contained in a sample; a detection unit 2 configured to measure a predetermined physical quantity of the compound flowing out of the column; a measurement condition storage unit 411 in which one or a plurality of measurement conditions are stored; a measurement control unit 423 configured to set an operation of measuring each of a plurality of samples using any one of the measurement conditions stored in the measurement condition storage unit a plurality of times for each sample and execute all measurement operations set for the plurality of samples in random order; and a measurement data processing unit 424 configured to associate measurement data acquired by the detection unit with a sample to be measured for each measurement.

### TECHNICAL FIELD

The present invention relates to a chromatograph such as a gas chromatograph or a liquid chromatograph.

### BACKGROUND ART

In recent years, in order to detect diseases such as cancer at an early stage, a compound (biomarker) specifically contained in a biological metabolite from a person having a specific disease has been searched for. When a biomarker is searched for, a biological metabolite in a diseased person (patient) and a biological metabolite in a non-diseased person (healthy person) are prepared as samples, and data obtained by measuring the samples are compared with each other to search for a compound contained only in the biological metabolite in the patient.

For searching for a biomarker, for example, a chromatograph mass spectrometer is used. Methods for searching for a biomarker by measurement using a chromatograph mass spectrometer include target analysis method and non-target analysis method (for example, Patent Literature 1). When target analysis is performed, a plurality of known compounds are determined in advance as candidates for biomarkers. Then, for each of the plurality of compounds, a time (retention time) at which the compound flows out from a column of the chromatograph and a mass-to-charge ratio of ions characterizing the compound are determined with reference to a database prepared in advance, and a method file describing measurement conditions of the plurality of compounds is created. Then, a batch file in which a method file is associated with each of the plurality of samples is created, the batch file is executed to sequentially measure the plurality of samples, and measurement data of each of the plurality of samples is acquired.

When non-target analysis is performed, a biomarker candidate is not determined in advance. but a method file is created for each of a plurality of samples for performing scan measurements in a predetermined mass-to-charge ratio range repeated at a predetermined time interval from start to end of a measurement of a sample. Further, a batch file is created in which a method file is associated with each of the plurality of samples. Then the batch file is executed to sequentially measure the plurality of samples, and measurement data of each of the plurality of samples is acquired.

When a biomarker is searched for, samples (sample group) derived from a biological metabolite in a plurality of patients and samples (sample group) derived from a biological metabolite in a plurality of healthy persons are used, and the plurality of samples are measured under the same measurement condition a plurality of times to acquire measurement data. This is done in order to avoid that a mass peak accidentally appearing due to noise at the time of measurement or the like is erroneously identified as a mass peak corresponding to a compound as a biomarker. In this way, by measuring the same sample a plurality of times to acquire measurement data and comparing a plurality of pieces of measurement data for the same sample with each other, it is possible to eliminate a peak that accidentally appears. After such processing is performed, multivariate analysis is performed on all the measurement data to search for a compound specifically contained in the sample group derived from the biological metabolites in the patients.

### CITATION LIST

### Patent Literature

Patent Literature 1: JP 2019-074403 A

### SUMMARY OF INVENTION

### Technical Problem

Conventionally, in a case where a plurality of samples are measured a plurality of times under the same measurement condition, a batch file for measuring all the samples is created such that a first sample is injected and measurements of the first sample are repeated a plurality of times, subsequently a next sample is injected and its measurements are repeated a plurality of times, and so on.

However, when a plurality of samples containing compounds such as biological metabolites are measured many times for each of the samples, the state of the column of the chromatograph may gradually change, and some of the compounds may remain in the column. As a result, there has been a problem in which, while correct measurement is performed for samples measured at the beginning of a series of measurements, accurate analysis cannot be performed for samples measured at the end: the time when a compound contained in the sample flows out from the column deviates from the original retention time due to a change in the state of the column, so that the sample is erroneously identified as another compound, a compound actually contained in the sample is not detected, or a compound contained in another sample measured before is erroneously detected at the time of measuring a subsequent sample.

An object of the present invention is to provide a technique capable of accurately analyzing all samples when performing analysis of measuring a plurality of samples a plurality of times using a chromatograph.

### Solution to Problem

A chromatograph according to the present invention made to solve the above problem includes:
a column configured to separate a compound contained in a sample;
a detection unit configured to measure a predetermined physical quantity of the compound flowing out of the column:
an information storage unit in which one or a plurality of measurement conditions are stored;
a measurement control unit configured to set an operation of measuring each of a plurality of samples using any one of the measurement conditions stored in the information storage unit a plurality of times for each sample and execute all measurement operations set for the plurality of samples in random order; and
a measurement data processing unit configured to associate measurement data acquired by the detection unit with a sample to be measured for each measurement.

### Advantageous Effects of Invention

In the chromatograph according to the present invention, the measurement control unit sets the operation of measuring each of the plurality of samples using any one of the measurement conditions stored in the information storage unit a plurality of times for each sample, and executes all the measurement operations set for the plurality of samples in random order. Then, the measurement data processing unit associates the measurement data acquired by the detection unit with the sample to be measured for each measurement. In the chromatograph according to the present invention, even if the state of the column changes during the execution of a series of measurements and, for example, the retention time of the compound in the sample measured at the end deviates, it is possible to accurately analyze all the samples by finding that there is an error in the data measured at the end by comparison with the measurement data before such a state change occurs and excluding the measurement data having the error.

### BRIEF DESCRIPTION OF DRAWINGS

FIG. 1 is a configuration diagram illustrating main components of a liquid chromatograph mass spectrometer, which is an embodiment of a chromatograph according to the present invention.

FIG. 2 is an example of a compound table used in the present embodiment.

FIG. 3 is an example of measurement contents described in a method file in the present embodiment.

FIG. 4 is an example of a batch file created in the present embodiment.

FIG. 5 is an example in which an execution order is assigned to a batch file created in the present embodiment.

### DESCRIPTION OF EMBODIMENTS

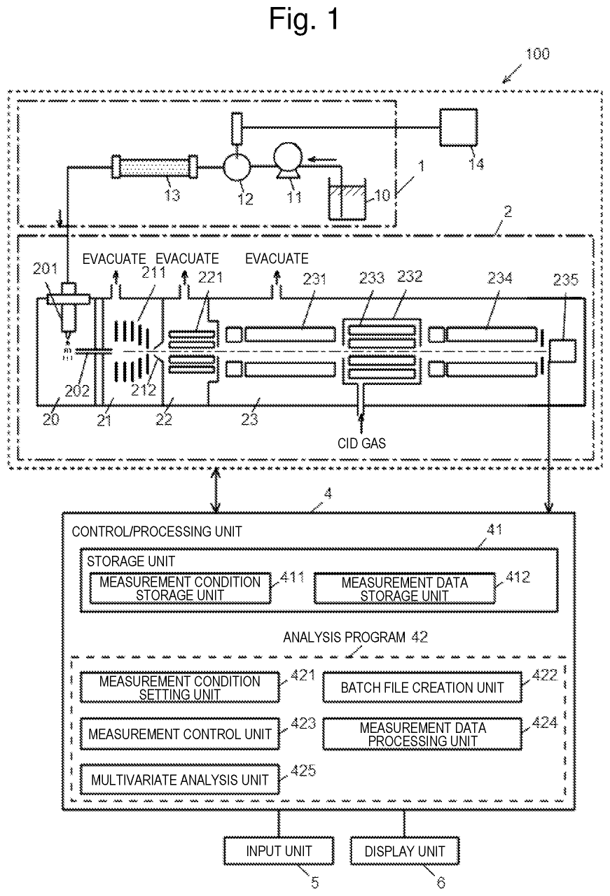

Hereinafter, an embodiment of a chromatograph according to the present invention will be described with reference to the drawings. FIG. 1 is a configuration diagram of main components of a liquid chromatograph mass spectrometer 100 of the present embodiment including a triple quadrupole mass spectrometer as a detection unit.

The liquid chromatograph mass spectrometer 100 of the present embodiment mainly includes a liquid chromatograph unit 1, a mass spectrometer unit 2, and a control/processing unit 4 for controlling operations of these units. The liquid chromatograph unit 1 includes a mobile phase container 10 in which a mobile phase is stored, a pump 11 for drawing the mobile phase and supplying the mobile phase at a fixed flow rate, an injector 12 for injecting a predetermined amount of sample liquid into the mobile phase, and a column 13 for temporally separating various compounds contained in the sample liquid. The liquid chromatograph unit 1 is connected to an autosampler 14 for introducing a plurality of preset samples one by one into the injector 12.

The mass spectrometer unit 2 includes an ionization chamber 20 at substantially atmospheric pressure and a vacuum chamber connected to the ionization chamber. The vacuum chamber includes a first intermediate vacuum chamber 21, a second intermediate vacuum chamber 22, and an analysis chamber 23 in this order from the side of the ionization chamber 20, and has a configuration of a multi-stage differential evacuation system with increasing degree of vacuum in this order.

The ionization chamber 20 is provided with an electrospray ionization probe (ESI probe) 201 for nebulizing sample solution while imparting electric charges to the sample solution. The ionization chamber 20 and the first intermediate vacuum chamber 21 are communicatively connected with each other via a heated capillary 202 having a small diameter. Although the ESI probe 201 is used as an ionization source in the present embodiment, another atmospheric pressure ionization source such as an APCI probe or an appropriate type of ionization source (such as a laser ionization source and a photoionization source), according to the characteristics of the sample can be used.

The first intermediate vacuum chamber 21 and the second intermediate vacuum chamber 22 are separated from each other by a skimmer 212 having a small hole at its top. A first ion guide 211 is provided in the first intermediate vacuum chamber 21, and a second ion guide 221 is provided in the second intermediate vacuum chamber 22. The first ion guide 211 and the second ion guide 221 transport ions to a rear stage while converging the ions.

In the analysis chamber 23, a front-stage quadrupole mass filter (Q1) 231, a collision cell 232 in which a multipole ion guide (q2) 233 is installed, a rear-stage quadrupole mass filter (Q3) 234, and an ion detector 235 are installed in this order from the upstream side (the side of the ionization chamber 20). A collision-induced dissociation (CID) gas such as argon and nitrogen is appropriately supplied into the collision cell 232 according to measurement conditions.

The mass spectrometer unit 2 can perform selected ion monitoring (SIM) measurement, MS/MS scan measurement (product ion scan measurement, precursor ion scan measurement), multiple reaction monitoring (MRM) measurement, and the like.

In the SIM measurement, the ions are not sorted by the front-stage quadrupole mass filter (Q1) 231 (not caused to function as a mass filter), and the ions are detected while the mass-to-charge ratio of the ions passing through the rear-stage quadrupole mass filter (Q3) 234 is fixed.

In the product ion scan measurement, while the mass-to-charge ratio of precursor ions passing through the front-stage quadrupole mass filter (Q1) 231 is fixed, and the mass-to-charge ratio of product ions passing through the rear-stage quadrupole mass filter (Q3) 234 is scanned, the product ions having passed through the rear-stage quadrupole mass filter (Q3) 234 are detected.

In the MRM measurement, while both the mass-to-charge ratio of precursor ions passing through the front-stage quadrupole mass filter (Q1) 231, and the mass-to-charge ratio of product ions passing through the rear-stage quadrupole mass filter (Q3) 234 are fixed, the product ions having passed through the rear-stage quadrupole mass filter (Q3) 234 are detected. In the precursor ion scan measurement, while the mass-to-charge ratio of precursor ions passing through the front-stage quadrupole mass filter (Q1) 231 is scanned, and the mass-to-charge ratio of product ions passing through the rear-stage quadrupole mass filter (Q3) 234 is fixed, the product ions having passed through the rear-stage quadrupole mass filter (Q3) 234 are detected. In these measurements, CID gas is supplied into the collision cell 232 to cleave precursor ions and generate product ions.

The control/processing unit 4 includes a storage unit 41. The control/processing unit 4 includes, as functional blocks, a measurement condition setting unit 421, a batch file creation unit 422, a measurement control unit 423, a measurement data processing unit 424, and a multivariate analysis unit 425. An entity of the control/processing unit 4 may be a personal computer, and each functional block described above is embodied by a processor executing an analysis program 42 preinstalled in the computer. An input unit 5 and a display unit 6 are connected to the control/processing unit 4.

The storage unit 41 is provided with a measurement condition storage unit 411 and a measurement data storage unit 412. The measurement condition storage unit 411 stores a compound table in which, for a plurality of known compounds, information such as names, chemical formulas, and molecular weights of the compounds, mass-to-charge ratios of precursor ions and product ions (MRM transitions) characteristic of the compounds, and retention times when component separation is performed by the column 13 is described.

Next, a procedure for an analysis using the chromatograph mass spectrometer 100 of the present embodiment is described. A case will be described in which compounds contained in a plurality of samples (patients 1 to 50) derived from biological metabolites in each of 50 patients with a specific disease and a plurality of samples (healthy persons 1 to 50) derived from biological metabolites in 50 healthy persons who do not have the disease are measured, and a compound (biomarker) specifically contained in the samples derived from the patients is searched for. In this example, target analysis is performed in which a plurality of known compounds are determined in advance as candidates for biomarkers and the compounds are measured.

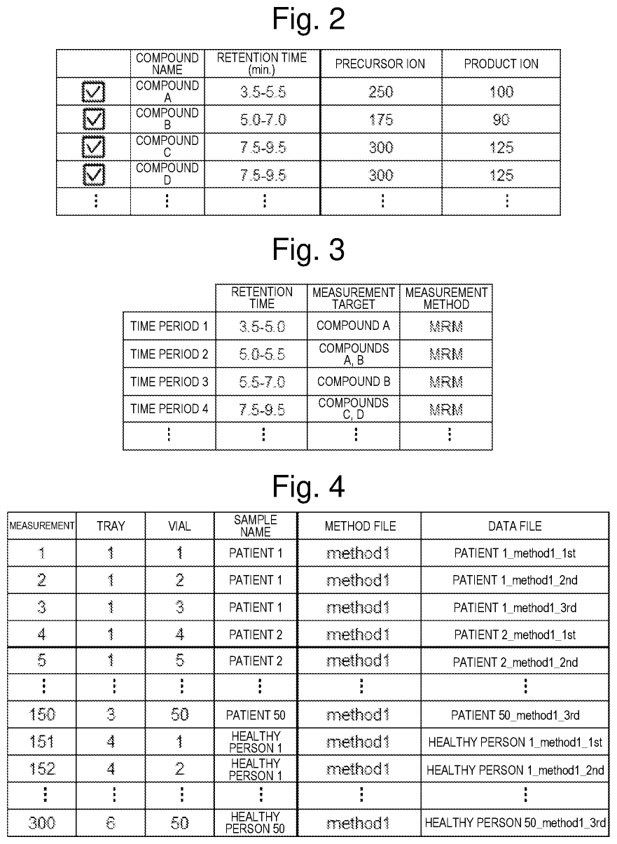

When a user gives an instruction to start analysis by a predetermined input operation, the measurement condition setting unit 421 displays the compound table stored in the measurement condition storage unit 411 on a screen of the display unit 6 (see FIG. 2). The compound table is displayed, for example, in the form of a list of compounds, and each compound is set as a measurement target by selecting a check box corresponding to the compound.

After the compound that is a measurement target is set, the measurement condition setting unit 421 subsequently reads the retention time and the mass-to-charge ratio of the MRM transition of each compound, and creates a method file describing measurement conditions including the retention time and the mass-to-charge ratio. In this embodiment, since the same compound is measured for all the samples, a method file common to all the samples is used. FIG. 3 is an example of measurement contents described in the method file. In this example, the MRM measurement of compound A is performed in time period 1, the MRM measurement of compounds A and B is alternately performed in time period 2, the MRM measurement of compound B is performed in time period 3, and the MRM measurement of compounds C and D is alternately performed in time period 4. When the content of the method file is determined, the measurement condition setting unit 421 adds a file name (method1) to the method file and stores the method file in the measurement condition storage unit 411.

The user subsequently inputs a sample name. As the sample name, for example, names such as patient 1, patient 2, . . . healthy person 1, healthy person 2, . . . are used. When the user inputs a sample name, a measurement data file name including the sample name of the sample is set for each sample.

Next, the batch file creation unit 422 creates a batch file for measuring a plurality of samples a plurality of times under the same condition. As illustrated in FIG. 4, in each row in the batch file, a measurement number, a tray number, a vial number, a sample name, a method file name, and a data file name are described. The tray number is a number of a tray to be set in the autosampler 14, and the vial number is a number of a plurality of vial accommodating portions provided in the tray.

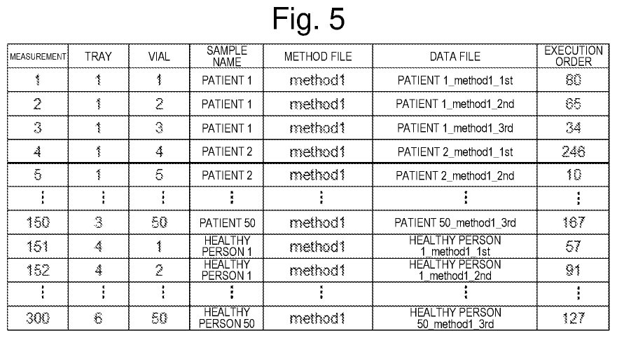

After the batch file is created, when the user gives an instruction to start measurement by a predetermined input operation, the measurement control unit 423 randomly determines the execution order of each row in the batch file, and describes the execution order in each row (right end field in FIG. 5).

Subsequently, the measurement control unit 423 executes the measurement described in each row in the determined execution order. The measurement data processing unit 424 associates the measurement data acquired for each measurement with the information on the execution order of the measurement, and stores the measurement data in the measurement data storage unit 412 with the data file name (data file name including sample name) described in the batch file.

When the measurement of all the rows described in the batch file is completed, the multivariate analysis unit 425 reads all the measurement data from the measurement data storage unit 412, and creates a table in which the sample name, the detected compound (ionic species), the retention time of the compound, and the measurement intensity (for example, area value) of the compound are described for each measurement data. Then, tables created from a plurality of pieces of measurement data (here, three pieces of measurement data) of the same sample are compared with each other, and data of a compound present only in one piece of measurement data (abnormal data) is deleted. As a result, data caused by accidental noise or the like is removed. The measurement data and the table before the abnormal data is removed may be displayed on the screen of the display unit 6, the abnormal data to be removed may be presented to the user, and the data may be removed only when the user approves the removal.

After completing the processing of removing abnormal data for all the samples, the multivariate analysis unit 425 subsequently performs multivariate analysis on the measurement data of all the samples (that is, all 300 pieces of measurement data). Since the contents of the multivariate analysis are similar to those conventionally performed, detailed description thereof will be omitted. The multivariate analysis unit 425 performs multivariate analysis on the above tables created from the plurality of measurement data to search for a compound specifically detected only in the samples derived from biological metabolites in the patients, and displays the result on the screen of the display unit 6.

When a large number of samples containing a large number of compounds such as biological metabolites are sequentially and continuously measured, the state of the measurement system may gradually change in the course of performing a series of measurements, for example, the state of the column 13 of the liquid chromatograph unit 1 gradually changes, some of the compounds remain in the column 13, or some of the compounds adhere to an electrode of the mass spectrometer unit 2.

Conventionally, when a plurality of samples are each measured a plurality of times under the same measurement condition using a liquid chromatograph mass spectrometer, all samples are measured in the order of performing injection and measurement of a first sample (patient 1) a plurality of times and subsequently performing measurement of a next sample (patient 2) a plurality of times. As a result, there has been a problem in which, while correct measurement is performed for a sample measured at the beginning of a series of measurements, accurate analysis cannot be performed for a sample measured at the end because the time when the compound contained in the sample flows out from the column deviates from the original retention time due to a gradual change in the state of the column 13 or the state of the electrode or the like of the mass spectrometer unit 2, or the electric field formed by the front-stage quadrupole mass filter 231 or the rear-stage quadrupole mass filter 234 is disturbed, so that the compound contained in the sample is erroneously identified, the compound actually contained in the sample is not measured, or a compound contained in another sample measured before the measurement of the sample is measured at the time of measuring the sample.

On the other hand, in the liquid chromatograph mass spectrometer 100 of the present embodiment, the measurement control unit 423 randomly determines the measurement execution order of each row of the batch file stored in the measurement condition storage unit 411 and executes each measurement. Then, the measurement data processing unit 424 stores the measurement order of the samples and the measurement data acquired at each measurement time in the measurement data storage unit 412 in association with each other. In the liquid chromatograph mass spectrometer 100 of the present embodiment, even if the state of the column 13, the electrode of the mass spectrometer unit 2, and the like changes during the execution of a series of measurements and, for example, the retention time of the compound in the sample measured at the end deviates, it is possible to accurately analyze all the samples by finding that there is an error in the data measured at the end by comparison with the measurement data before such a state change occurs and excluding the measurement data having the error.

A batch file for executing a plurality of samples in random order can be created by the user manually rearranging rows of the batch file. However, in the measurement of searching for a biomarker as in the above example, the number of times of measurement is generally several hundred times in total, and it takes time and effort for the user to manually rearrange the rows in the batch file corresponding to the several hundred times of measurement. Even if the user himself/herself is not conscious, there is a case where the habit of the user is reflected in the rearrangement of each row and the rows are not necessarily rearranged randomly. Therefore, in the above embodiment, the measurement control unit 423 performs processing of automatically and mechanically rearranging the measurement order randomly.

The above-described embodiment is merely an example, and can be appropriately modified in accordance with the spirit of the invention. In the above embodiment, the case where measurement is performed three times for the same sample has been described, but when higher accuracy is required in multivariate analysis, measurement may be performed four times or more for the same sample. In the above embodiment, the multivariate analysis unit 425 removes abnormal data before performing multivariate analysis, but it is not essential to perform multivariate analysis. When multivariate analysis is not performed, the measurement data processing unit 424 may be configured to remove abnormal data.

In the above embodiment, after the batch file creation unit 422 creates the batch file, the measurement control unit 423 randomly determines the execution order of the measurement of each row in the batch file, but other methods can be adopted. For example, after a user inputs a sample name and a measurement data file name including the sample name of the sample is set for each sample, the batch file creation unit 422 can create a batch file for measuring the plurality of samples a plurality of times under the same condition in random order, and the measurement control unit 423 can execute the measurement in order from the first row. That is, the batch file creation unit 422 may create a batch file in which each row in the batch file illustrated in FIG. 5 is sorted by item “execution order”.

In the above embodiment, the case of performing target analysis has been described, but the present invention can also be applied to non-target analysis. In the non-target analysis, scan measurement is performed without determining a compound to be measured in advance, and the compound is identified based on the mass-to-charge ratio of the detected ions. In a triple quadrupole mass spectrometer unit such as the mass spectrometer unit 2 used in the above embodiment, usually only information on the mass-to-charge ratio in an integer unit is obtained, and obtaining the information on a precise mass (for example, about three decimal places) necessary for estimating the composition of the compound may be failed. Therefore, in a case where non-target analysis is performed, it is preferable to use, as the mass spectrometer unit, one that can obtain the information on the precise mass (charge ratio) of ions, such as a quadrupole-time-of-flight (Q-TOF) type or an ion trap-time-of-flight (IT-TOF) type.

In non-target analysis, the mass-to-charge ratio of precursor ions cannot be determined in advance. Therefore, in the case of measuring product ions, first, mass spectrum data is acquired by scanning and measuring ions generated from a sample by normal scan measurement in a predetermined mass-to-charge ratio range, and a batch file is created using a method file for performing what is called a data-dependent MS/MS scan measurement in which, for example, a peak having the highest intensity is extracted from peaks on the mass spectrum and ions corresponding to the peak are used as precursor ions.

It is not essential in the present invention to generate product ions with a mass spectrometer. For example, when an ionization source capable of generating fragment ions directly from a sample, such as an electron ionization source or a chemical ionization source used in a gas chromatograph mass spectrometer, is used, a mass spectrometer having only a single mass filter may be used. It is not essential to the present invention to use a mass spectrometer as the detection unit, and for example, a spectrophotometer or the like can be used as the detection unit.

Although a liquid chromatograph is used in the above embodiment, a gas chromatograph can be used instead. In the above embodiment, an example of measurement for the purpose of searching for a biomarker has been described, but various other analyses can be performed. For example, the same analysis as in the above embodiment can also be used for analysis for specifying a compound (for example, a trace amount of additive) that contributes to a difference in characteristics between the same type of materials (for example, rubber and resin) having different manufacturers and the like.

### MODES

It is understood by those skilled in the art that the plurality of exemplary embodiments described above are specific examples of the following modes.

(Clause 1)

A chromatograph according to a mode includes:
a column configured to separate a compound contained in a sample;
a detection unit configured to measure a predetermined physical quantity of the compound flowing out of the column;
a measurement condition storage unit in which one or a plurality of measurement conditions are stored;
a measurement control unit configured to set an operation of measuring each of a plurality of samples using any one of the measurement conditions stored in the measurement condition storage unit a plurality of times for each sample and execute all measurement operations set for the plurality of samples in random order; and
a measurement data processing unit configured to associate measurement data acquired by the detection unit with a sample to be measured for each measurement.

In the chromatograph according to Clause 1, the measurement control unit sets the operation of measuring each of the plurality of samples using any one of the measurement conditions stored in the measurement condition storage unit a plurality of times for each sample, and executes all the measurement operations set for the plurality of samples in random order. Then, the measurement data processing unit associates the measurement data acquired by the detection unit with the sample to be measured for each measurement. In the chromatograph according to Clause 1, even if the state of the column changes during the execution of a series of measurements and, for example, the retention time of the compound in the sample measured at the end deviates, it is possible to accurately analyze all the samples by finding that there is an error in the data measured at the end by comparison with the measurement data before such a state change occurs and excluding the measurement data having the error.

(Clause 2)

In the chromatograph according to Clause 1,
the detection unit is a mass spectrometer.

The chromatograph according to Clause 2 is what is called a chromatograph mass spectrometer. Since the mass spectrometer is an analyzer having both high compound selectivity and high measurement sensitivity, the chromatograph according to Clause 2 can analyze a sample with high accuracy and high sensitivity.

(Clause 3)

The chromatograph according to Clause 1 or 2 further includes
a multivariate analysis unit configured to perform multivariate analysis on the measurement data of the plurality of samples to search for a characteristic compound contained in samples having the same attribute.

The chromatograph according to Clause 3 is suitably used in analysis of a sample group having different attributes. In this chromatograph, the multivariate analysis unit can obtain the information on the characteristic compound contained in the samples having the same attribute without the user analyzing the measurement data.

(Clause 4)

In the chromatograph according to Clause 3,
the multivariate analysis unit is configured to compare a plurality of pieces of measurement data acquired for a same sample with each other before performing the multivariate analysis, and remove data present only in a part of the plurality of pieces of measurement data.

In the chromatograph according to Clause 4, since the data present only in a part of the plurality of pieces of measurement data acquired for the same sample is removed before the multivariate analysis is performed, it is possible to perform the multivariate analysis with higher accuracy by removing abnormal data caused by accidental noise or the like.

### REFERENCE SIGNS LIST

100 . . . Liquid Chromatograph Mass Spectrometer
1 . . . Liquid Chromatograph Unit
13 . . . Column
14 . . . Autosampler
2 . . . Mass Spectrometer Unit
20 . . . Ionization Chamber
201 . . . Electrospray Ionization Probe
21 . . . First Intermediate Vacuum Chamber
211 . . . First Ion Guide
22 . . . Second Intermediate Vacuum Chamber
221 . . . Second Ion Guide
23 . . . Analysis Chamber
231 . . . Front-Stage Quadrupole Mass Filter
232 . . . Collision Cell
233 . . . Multipole Ion Guide
234 . . . Rear-Stage Quadrupole Mass Filter
235 . . . Ion Detector
4 . . . Control-and-Processing Unit
41 . . . Storage Unit
411 . . . Measurement Condition Storage Unit
412 . . . Measurement Data Storage Unit
42 . . . Analysis Program
421 . . . Measurement Condition Setting Unit
422 . . . Batch File Creation Unit
423 . . . Measurement Control Unit
424 . . . Measurement Data Processing Unit
425 . . . Multivariate analysis Unit

1. A chromatograph comprising:
a column configured to separate a compound contained in a sample;
a detection unit configured to measure a predetermined physical quantity of the compound flowing out of the column;
an information storage unit in which measurement conditions of a plurality of samples are stored;
a measurement control unit configured to measure each of the plurality of samples a plurality of times in random order using the measurement conditions stored in the information storage unit and the column; and
a measurement data processing unit configured to associate measurement data acquired by the detection unit with a sample to be measured for each measurement.

2. The chromatograph according to claim 1, wherein the detection unit is a mass spectrometer.

3. The chromatograph according to claim 1, further comprising a multivariate analysis unit configured to perform multivariate analysis on the measurement data of the plurality of samples to search for a characteristic compound contained in samples having a same attribute.

4. The chromatograph according to claim 3, wherein the multivariate analysis unit is configured to compare a plurality of pieces of measurement data acquired for a same sample with each other before performing the multivariate analysis, and remove data present only in a part of the plurality of pieces of measurement data.
